(19) United States
(12) Patent Application Publication
(10) Pub. No.: US 2009/0132690 A1
(43) Pub. Date: May 21, 2009

(54) On-Demand Download Network

(75) Inventor: Tareq Hafez, Marsfield (AU)

Correspondence Address: MICHAEL MOLINS;MOLINS & CO., SUITE 5, LEVEL 6, 139 MACQUARIE ST, SYDNEY NSW, 2000, AU

(73) Assignee: Retail Information Systems Pty Ltd, Bondi Junction NSW (AU)

(21) Appl. No.: 11/942,714

(22) Filed: Nov. 20, 2007

(51) Int. Cl. G06F 15/173; G06F 9/44

(52) U.S. Cl. 709/223; 717/173

(57) ABSTRACT

A device retrieves only the application software that is missing on the device and is currently required to perform a certain function. An object-request module sends a request that identifies only the needed application.

### FIELD OF THE INVENTION

This technology pertains to data transfer between a host and a device, in particular, a data transfer between a host and a thin client.

### BACKGROUND OF THE INVENTION

Some retail stores are provided with payment devices such as bank card or credit card readers. These devices may be deployed with payment application software that facilitates transactions such as payment or reward program transactions. These devices may further be deployed with value added applications (VAA) along with the payment application.

The entire payment application may need to be redeployed to the device when an addition or a change is made to any of the VAAs on the device, or to the payment software itself. This redeployment introduces windows of attack for potential security risks. Also, redeployment of a payment software is time-consuming. Redeployment may involve a lengthy certification and deployment period. These problems restrict the ability of financial transaction acquirers to quickly introduce new payment features to their software. The problems also introduce significant costs whenever an upgrade to the software is required, for example, to fix a business or technical issue. The costs incurred include a communication cost that is proportional to the number of devices installed

### OBJECTS AND SUMMARY OF THE INVENTION

It is an object of the present technology to minimize the number and size of downloads that a payment device requires from a host.

It is another object of the present technology to provide a device that only downloads whichever software portion that has been changed or that the device lacks.

### BRIEF DESCRIPTION OF THE DRAWING FIGURES

In order that the invention be better understood, reference is now made to the following drawing figures in which:

FIG. 1 is a schematic diagram depicting a data flow between a host, a device, and an external host;

FIG. 2 is a schematic diagram depicting a host;

FIG. 3 is a schematic diagram depicting a device;

FIG. 4 is a flowchart depicting a normal operation of the device;

FIG. 5 is a flowchart depicting the host's behaviour when an out-dated application object is detected;

FIG. 6 is a schematic diagram depicting the server instruction object;

FIG. 7 is a flowchart depicting an initialisation process for the device;

FIG. 8 is a schematic diagram depicting the mandatory object; and

FIG. 9 is a schematic diagram depicting a display application object.

### BEST MODE AND OTHER EMBODIMENTS OF THE INVENTION

By way of example, this technology is described in the context of a payment device such as a bankcard and credit card reader. It should be understood that the same technology caters to other devices such as mobile phones and computers. Also, although the technology is described in the context of a payment transaction, the technology is applicable for other purposes, such as, without limitation, loyalty program applications, prepaid mobile top-up applications, and music download applications.

### 1. Overview

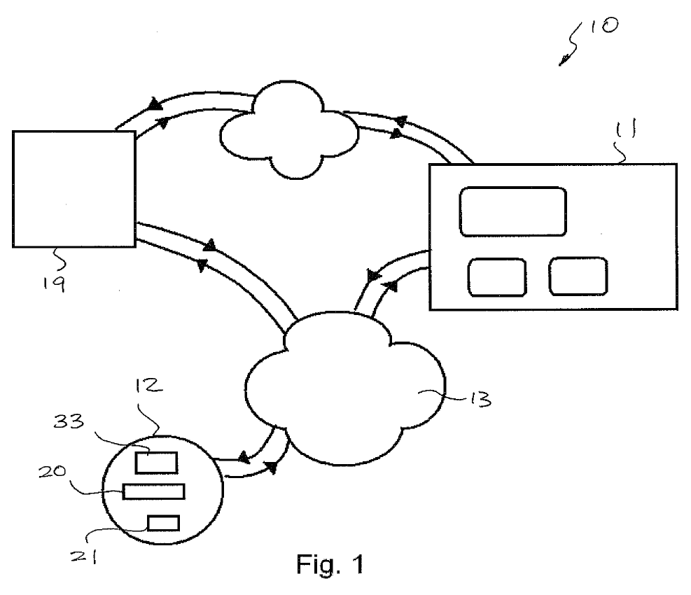

As shown in FIG. 1, the on-demand thin client download network 10 comprises a host (or “server”) 11 and one or more uniquely identified payment devices (or “devices”) 12. The device 12 is modified to become a thin client that requests data or applications from the host in an on-demand fashion. While different type of devices 12 may be used, the device used needs to have a persistent memory 20. A persistent memory does not lose its content during a device shut-down. The device further needs to have a user input area 21 (e.g. a key pad or a scroller) that allows an operator to control the device.

The host 11 and the device 12 communicate over a communications network 13. The host 11 and the device 12 preferably engage in bi-directional communication, allowing the device 12 to send transaction data to the host 11 and the host 11 to download application objects to the device 12. Payment transactions are performed by the device 12. The device 12 is a thin client, and may or may not have the application software (i.e. application object) that is needed to complete the transactions. The device 12 requests a missing but required object from the host 11. The device 12 also transmits data objects which contain encoded transaction details to the host 11, the transaction being the relevant “event” associated with the data object.

In the embodiments explained herein, the network 10 utilizes object oriented programming. Each data generated by the device or host is a data object. The software responsible for, for instance, the payment for a purchase, is encoded into one or more application objects. Features such as VAAs are also encoded as application objects. Each image that is displayed by the device 12 is encoded as an image or graphic object. These objects are preferably text-based with 8-bit Unicode Transformation Format support for large character sets (e.g. Chinese characters), and can be represented using a Java Script Object Notation (JSON) or the Extensible Mark-up Language format (XML). Each of the aforementioned objects may have several fields. Each field can be a tag and value pair, or it can be an internal object that is nested within the main object. The value of each field is alpha-numerical, but may be purely alphabetical or purely numerical. Examples of the different objects that may be utilized in the present technology are described in Appendix A. For the purpose of simplicity, in the rest of this specification, a field is referred to according to its “tag”. For example, a “type field” refers to a field whose tag is “type.”

### 2. The Host

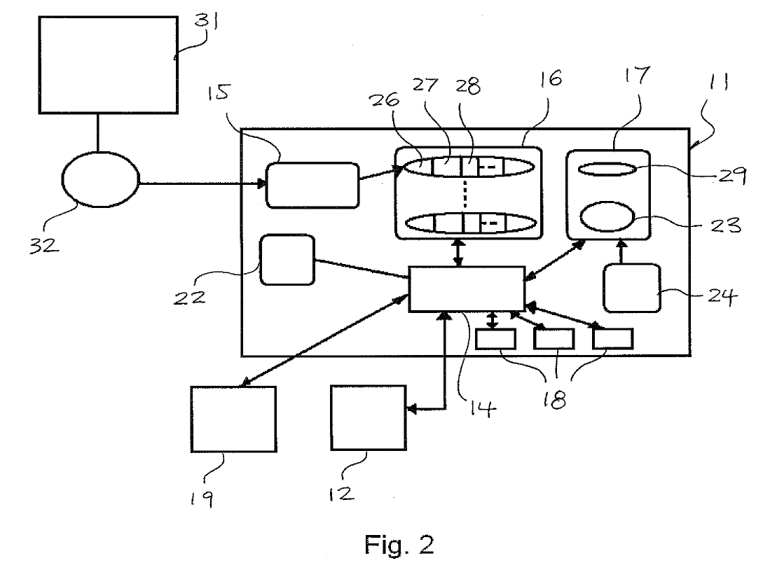

As shown in FIG. 2, the host 11 comprises a management module 14 that oversees and manages the routing of the data flow between the host 11 and the device 12, and between the host 11 and any external or third party server 19. The management module also handles the upgrading and the deployment of application objects to devices 12. In preferred embodiments, the management module 14 generates responses 30 to indicate, without limitation, the success or failure of an object transmission, the requirement for an addition or a change in the device's application objects, or the success or failure of the host 11 to accept a data generated by the device 12.

An importing tool 15 accepts text data 32, such as those created by an external JSON or XML text editor, and compacts the text data into an object 25. The object is then stored into a host object database 16. In this way, new applications, instructions, or tools can be created and added to the host 11. The type of object created depends on the information contained in the data. For example, each object has a “type” field 26 (i.e. the tag is “type”) that specifies whether the object is a data object, an application object, or an instruction object. The “type” field 26 indicates whether the object is a data object, an application object, or an instruction object. Each object may further have a “name” field 27 (i.e. the tag is “name”) that specifies the nature of the object. For example, a data object may be a transaction data or a reward program data. Preferably, a data object or an application object further has a “version” field 28 (i.e. the tag is “version”). The content of the version field 28 denotes the version of the object, and is useful for the purpose of upgrading application objects.

In preferred embodiments, the management module 14 in the host 11 further has the capability to enable or disable an object that is created by the importing tool 15. A disabled object is prevented from being downloaded by a device 12. In some embodiments, there is a field or a flag, with each object, whose value is either enabled or disabled. Each object thus has either an enabled or a disabled status. In the current example, the management module 14 disables all of the objects in the database 16, except from the idle display object. In further preferred embodiments, the host 11 supports an interface such as an application programming interface 22, via which the content or the enabled status of each object can be modified by a programmer or an administrator.

The host 11 may support a configuration utility or module, such as a web page 24, for allowing an operator or a programmer to enter or modify the generic or configuration data for a device. This generic or configuration data may include, without limitation, the location of a device, the retailer who operates the device, and the serial number of the device. The configuration data for the devices are stored in a memory location 17 within or accessible by the host 11. In this example, the generic data pertaining to each device is stored as a “configuration object” 29. The configuration objects allow the host 11 to authenticate a device before transmitting data to that device.

The host 11 further comprises a device reference table or map, such as a download log 23. This log 23, available within the host's memory 17, contains each device's download records. Therefore this log 23 allows the management module 14 to determine what application objects have been downloaded by any particular device for which a configuration object exists.

Another function of the host 11 is to transmit transaction data generated by the device 12 to an appropriate third party. To accomplish this task, the host 11 further comprises one or more custom handlers 18. Each custom handler 18 is specific to one external host (or “third party host”) 19. Examples of external hosts include banks, credit card companies, and loyalty program providers. It is further possible that different custom handlers 18 may be provided to deal with data generated by two different versions (an older version and a new version) of the same application object. The management module 14 determines which custom handler 18 should be used by reading the type or name fields 26, 27 of the data object transmitted by the device 12.

A custom handler 18 has programmed into it data specifications required by an external host that the handler corresponds to. The custom handler 18 thus transforms the transaction data into a version that can be processed by the external host 19. The management module 14 then dispatches the transformed data to the appropriate external host 19. Similarly, the customer handler 18 is equipped to interpret responses that the management module 14 receives from the corresponding external host 19. The management module 14 may then relay the response to a suitable destination, for example, the device 12.

At the receipt of a device's request for a specific object, the management module 14 checks for the availability of the object requested within the host object database 16. The management module 14 further checks that the device 12 from which the request originates from does not already have this object. This status check can be performed, for example, by referring to the download log 23 within the host's memory 17. The requested object is sent to the requesting device 12 if the management module 14 determines that the requested object does not already exist.

### 3. Device Architecture and Operation

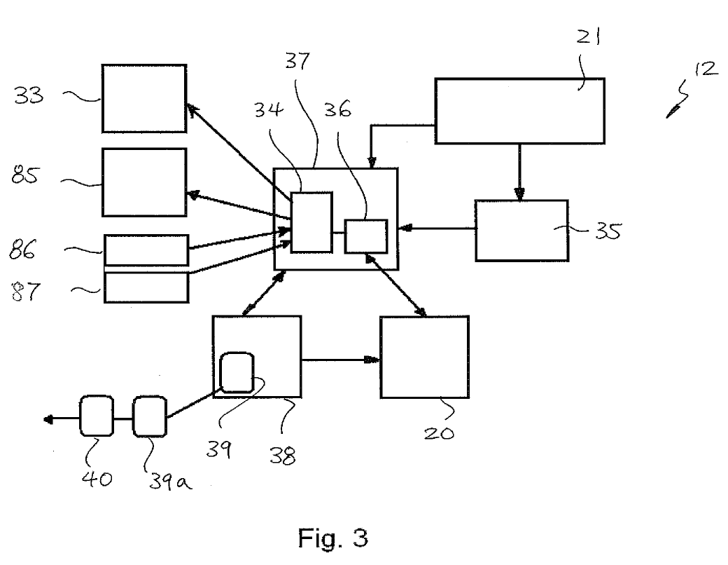

Referring to FIG. 3, each device 12 comprises a user input (or “user input area”) 21, a display 33, and a persistent memory 20. The user input area 21 may be, for example, a key pad or one or more switches. In some embodiments, the device 12 may have access to, or may include, additional hardware such as a printer 85, a card reader 86, or a barcode scanner 87. In these embodiments the selection or external input may come from the any of the user input area 21, the card reader 86, and the barcode scanner 87. The device 12 further comprises a display module 34 that is responsible for controlling the display 33. By controlling the user input 21, an operator can select to perform a certain function. In some embodiments, the selection or external input from the user input area 21, the card reader 86, or the scanner 87, causes an object-name software module (or “object-name module”) 35 to generate or identify the names of the application objects that are needed to perform the function. For example, a scan of a barcode by the barcode scanner 87 causes the object-name module 35 to identify the names of the application objects that are needed to add the external input (i.e. the barcode scanned) to a purchase basket. In another example, a swipe of a bank card causes the object-name module 35 to identify the names of the application objects that are needed to send payment details to the bank. In this scenario the “external input” would be the bank card data as read by the card reader 86.

The object-name module 35 transmits the names to an object-location software module (or “object-location module”) 36. The object-location module 36 locates, in the persistent memory 20, the application objects having those names. In other embodiments, the selection of a function may directly cause the object-location module 36 to attempt to locate the required application objects from the device memory 20.

In some preferred embodiments, the display module 34 and the object-location module 36 both belong to an animation software module (or “animation module”) 37. For example, a successful location of a required application object allows an action corresponding to that object to be performed, and this in turn allows an image corresponding to that action to be shown by the display 33.

The device 12 further comprises an object-request software module (or “object-request module”) 38. From the object-location module 36, the object-request module 38 receives the names of the missing application objects that the device 12 lacks but needs to perform the selected function. This data that the object-location module 36 passes to the object request module 38 is also referred to as the “missing application object names.” For each of these missing application names, the object-request module 38 creates a different “request object” (or “request”, “request data object”) 39. The object-request module 38 compresses and encrypts the request 39. The object-request module 38 then sends the compressed and encrypted request object 39a, following a “mandatory object” 40, to the host 12.

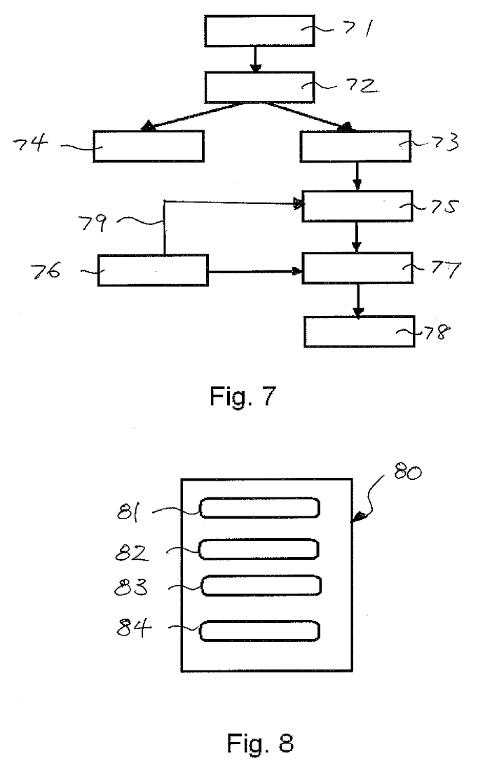

As will be explained (see FIG. 7), the mandatory object 40 has a “type field” value of “identity”. This signifies to the host 11 that the mandatory object 40 identifies the device 12 that is currently communicating to the host 11. The mandatory object further contains other information, such as the model number of the device, the manufacturer of the device, and the serial number of the device. The host's management module 14 (not shown) verifies the information contained in the mandatory object 40 with the data contained in the configuration object, and then performs the previously mentioned checks to determine whether it should transmit the requested object. Once the object-request module 38 receives the requested object, it writes the received object into the device memory 20. The received object overwrites the oldest available object in the persistent memory 20, if there is insufficient space left in the memory 20 to accommodate the received object. In other words the received objects are written into the device memory 20 on a first-in-first-out basis. In the event that the device 12 does not receive the requested object the object-request module 38 sends this “failure” response to the display module 34. The display module then causes a corresponding error message to be shown by the display 33. Within the present object-oriented technology, each response or error message is encoded as a “data object”.

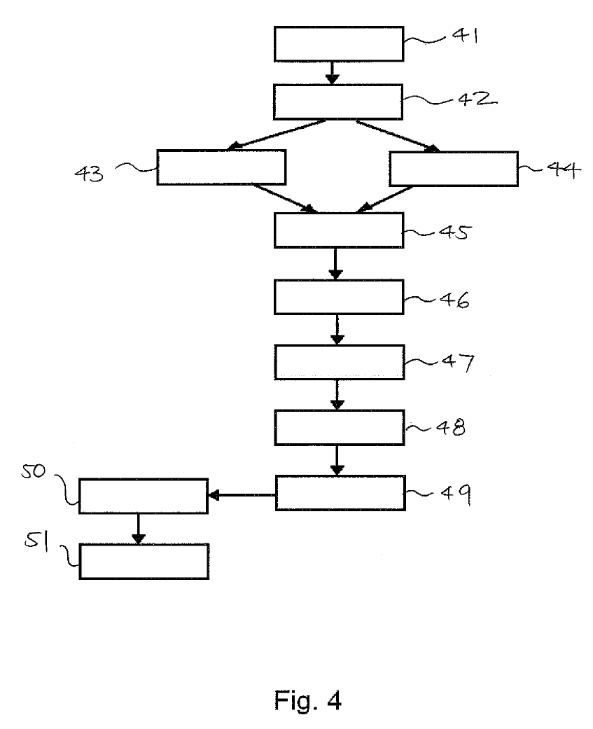

Referring to FIG. 4, in the event that the object-location module successfully finds all of the application objects needed 41, the device proceeds to use the application objects to perform the function selected 42. The overall control of the application objects may reside in the object-location module 43, or it may reside in the aforementioned animation module 44. Performing the selected function may involve, for example, recording a purchase amount in a transaction, reading a bank card number, and encrypting the bank card number for transmitting it. Each of these actions may involve the recording or the creation of a data element 45. An appropriate application object then writes the data elements into a “data object” 46. The data object is compressed and encrypted 47. The object-location module or the animation module then sends the aforementioned “mandatory object” 48. The object-location module or the animation module then sends the compressed and encrypted data object to the host 49. The object-location or the animation module may later receive a response from the host regarding this transaction 50. This response would then be sent to the display module to be shown 51.

### 4. Upgrading of Application Objects

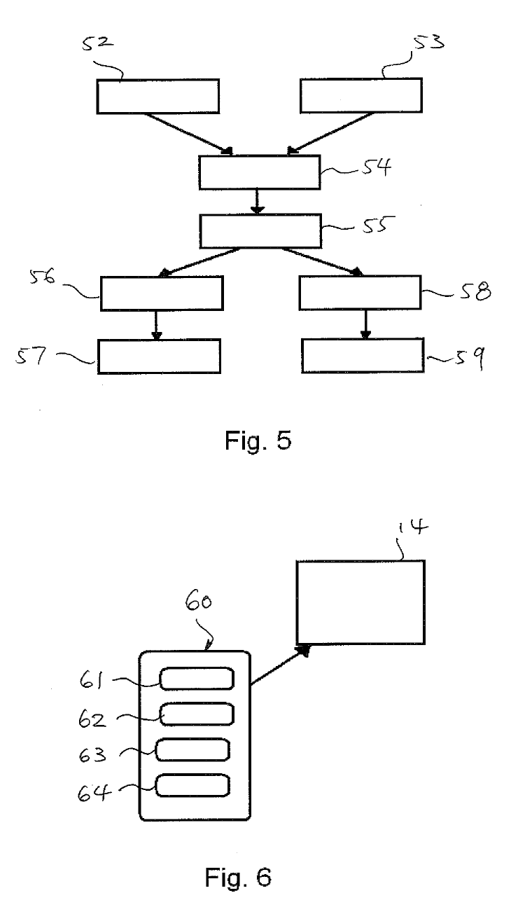

Available application objects may often need to be upgraded. Alternatively, new objects may need to be added as a result, for example, of a change in protocol, technology, or procedure. Referring to FIG. 5, whenever the host receives a request for an application object 52, it checks its memory to see whether a newer version of the application object exists 53. At the receipt of a data object 54, the host also checks to see whether the application objects that have been used to generate the received data object are up to date 53. In the event that the device already has a certain application object but that object is out-dated 55, the host may perform two actions. Which action is taken depends on the instruction that a programmer or an administrator provides through, for example, the application programming interface.

First, the host may accept the older version, by, for example, accepting a transaction data object generated using the older version of application object 56. The host can then issue a message to the device, to notify the operator of the availability of the new version for download 57. Second, the host may reject the data object generated by the older version of the application object 58, and then notify the operator that the new version must be downloaded 59.

### 5. Predictive Transmission of Application Objects

One way of minimising the communication cost involved in transmitting the application objects is to minimise the number of times that transmissions need to occur. The host achieves this by “predicting” future or correlated application objects that might be needed, based on the information found within the request object that is currently being processed. Referring to FIG. 6, the management module 14 of the host 11 has access to a “server instruction” object 60. The server instruction object comprises a “trigger field” 61, an “event field” 62, a “value field” 63, and one or more “download fields” 64. The host management module 14 is “triggered” to deploy all the application objects in the “download fields”, when the values of the “type field”, “name field”, and “event field” of the request object matches the values of the same fields in the server instruction object.

### 6. Initialisation of Device and Download Security

A “boot loader” software (i.e. the first software that runs when the device is turned on) and a certificate, such as an SSL certificate, must be injected into the device, in a secure facility, before the device is deployed. Before a deployed device becomes operational, it needs to be initialized.

Referring to FIG. 7, the device prompts the user or operator to select a communication network 71. The choice of communication network is not restricted. Various choices such as IP via Ethernet, Dial-up, WIFI, and GPRS, or any other network, are acceptable. Depending on the communication medium selected, the specific settings are prompted 72. Examples of the settings include, without limitation, the host's IP address, the host's TCP port number, a dial up phone number for the host, baud rate for data transmission. The device then requests an initialisation 73 and downloads an idle display object 74.

The initialisation 73 involves sending a request, for example an SSL request, for a master key 75. In this example the master key is a Key Encrypting Key (KEK) 3-DES symmetric key. The host then generates a new master key for the device 76. Various communications parameters such as a MAC, PIN and DATA session keys are then requested 77. These session keys are used in the previously mentioned encryption of transmitted data objects and request objects. Further, the response data objects that the host transmits to the device is also compressed and encrypted. Preferably, the request and response objects are encrypted using KEK variants. The session keys must change at least daily 78 as long as there is a need to send a request to the host. The host can request a full re-initialisation of the KEK or other session keys at any time 79.

All objects transferred from or to the host 11 are compressed and then encrypted. Furthermore, the device 12 must send the previously mentioned mandatory object as the first object in the request identifying itself. Referring to FIG. 8, this mandatory object 80 must have the following tags (or “fields”): a “type” field 81, a “serial number” field 82, a “manufacturer” field 83, and a “model” field 84. The serial number field contains the serial number of the device, the manufacturer field names the manufacturer of the device, and the model field names the device model

In particular, the value of “type” field 81 must be “identity” (or its equivalent in other implementations). This allows the mandatory object 80 to be recognized, by the host 11, as an identifier for the device 12 that will commence communication with the host 11.

### 7. Object Oriented Display and Data Segregation

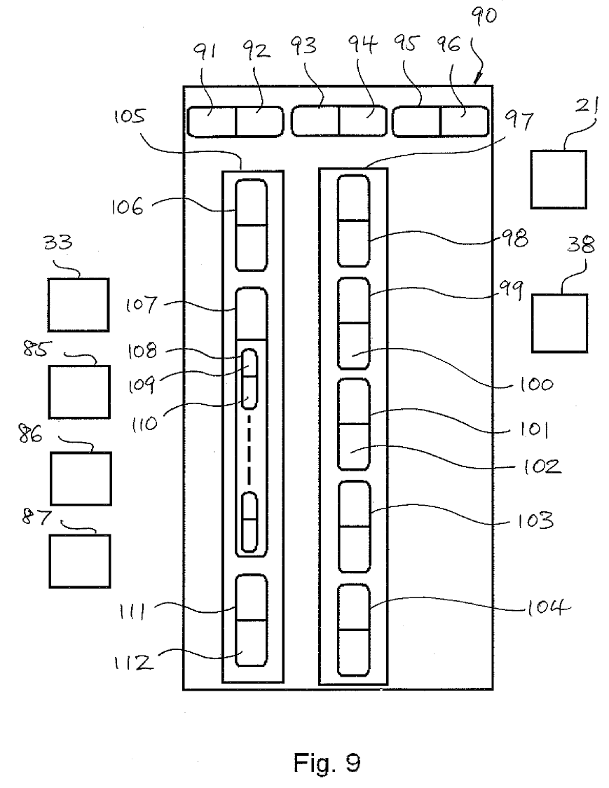

The majority of application objects that allow the operation of the device are “display application objects”. These are stored within the display module 34 of the device. Referring to FIG. 9, like most objects, a display application object 90 comprises a “type field” that has the tag “type” 91 and the value 92 “Display”. The object 90 further comprises a “name field” 93. The value 94 of “name field” can vary as prior mentioned. The object 90 also comprises a “version field” 95 whose value 96 indicates the current version of the display application object 90.

The display module receives input from the user input area 21. It also receives input from any additional input such as input from a barcode scanner 87 or a magnetic card reader 86 if one is available on the device. These inputs are used by the display application object 90 as described hereafter.

Specific to a display application object 90 are an array of “animation fields” 97. The “animation fields” array 97 specifies what is to be displayed, and also where within the display screen the displayed content should appear. This array includes an “animation type field” 98 whose value indicates the type of information or content that will be presented or displayed. For example, a graphical animation, a text, or a number could be the subject of the display. There is also an “object field” 99. The value 100 of “object field” indicates the specific content that will be displayed. In some cases, the specific content 100 may be a text table or a graph objects. Thus, there may also be a “reference field” 101 whose the value 102 of this field is a specific reference point within the content 100. Other fields that are needed by a display application object 90 include a “row field” 103 and a “column field” 104. These fields allow the position of the displayed content to be specified.

The display application object 90 further comprises an array of “path fields” 105. The information contained in this array defines when the current display object will exit the screen 33 (i.e. when the next display object will enter the screen 33). An “event type field” 106 specifies the event whose occurrence triggers the exit of a current display object. The event may be the swipe of a bank or credit card, or a connection to a modem, or perhaps the pressing of a button on the user interface 21. The occurrences of these events are monitored by the display module.

An “action field” 107 specifies the action that will occur once the triggering event occurs. In the current embodiment, the “action field” 107 is a nested object of internal fields 108. Each internal field is again an (internal) tag 109 and (internal) value 110 pair. Each internal tag 109 may be “relative” and refer only to one of the tags used by the current display object. Alternatively the internal tag 109 may be “absolute” and refer to any of the tags used by any of the existing objects. This is analogous to the use of a “relative” or “absolute” file path in web programming, where an absolute path for a file starts the path reference from the root directory for all files, whereas a “relative” path may name a path relative to a particular directory. The original value that accompanies the tag referenced by the internal tag 109 may be changed, as part of the action, to the internal value 110. The internal value 110 is a temporary data element. This element 110 may be, for example, a user interface key that is pressed, an alpha-numerical input that the operator enters, a data read from a track of a magnetic swipe, or a barcode that is read by a barcode reader or scanner. The internal value 110 may also be a return value generated by an internal function, for example, an internal function that transmits information via the device's object request module 38 to the host 11, or an internal function that sends information to be printed by a printer 85. A more complete list of possible functions can be found in a later part of the specification.

Another field in the array of “path fields” 105 is the “new display object” field 111. The value 112 of this field indicates the new object that should now enter the display screen. How the value is generated is explained later.

The above description for the display application object 90 shows that within the present technology, data is segregated according to an organizational structure for the object. Further, data is stored into arrays, where the arrays themselves are segregated according to the structure of an object. The modularity of the data also lends itself to applications where data elements from different functions or inputs need to be aggregated to form, for example, the value of a field.

According to the above disclosure, the present technology minimizes the size of the data that needs to be transmitted each time a new or updated (upgraded) application is required. The technology achieves this objective by making possible the “on-demand” requests, wherein only the presently needed application is requested and downloaded by the device. The technology also minimizes the number of data transmissions that are required. Further, this object oriented technology makes it possible for this “on-demand” download and request to be made in a secure manner, by authenticating the device before commencing any data transmission.

### 8. Examples of Other Application Objects

### Text Table Application Object

This object meets VISA Payment Card Industry (and similar) security standards by ensuring that no PIN text prompt appears anywhere in the application. It is envisaged that these text tables can be examined by a security expert without having to examine the entire application's objects. Aside from the “Type”, “Name”, and “Version” fields, two extra fields exist for an object of this type. These are the prompt field and the sign field. The prompt field is an array of prompt fields. Each prompt field is an array of 2 values: a prompt number and a prompt text. The sign field contains a unique cryptographic hash function signature, for example a SHA-1 signature, of all the values of the prompt fields in the order presented. The device must examine this signature before accepting and processing the text table object.

### Graphics Image Application Object

This object helps ensure that no PIN prompts appear anywhere in a graphics image. Aside from the “Type”, “Name”, and “Version” fields, two extra fields exist for an object of this type. These are “image field” and “sign field”. Each image field is an array of 3 values: an image number an image file name and a cryptographic signature of the content of the image file. The device can preferably support bmp, gif and animated gif images. The “sign field” contains a unique cryptographic signature of all the values of the graphic fields in the order presented. The device must examine this signature before accepting and processing the graphics image application object.

### Font Table Application Object

Besides providing extra fonts, this object helps ensure that no PIN prompts appear anywhere. Since it is possible to manipulate the font to display different characters, it is important that fonts are placed in a secure table. Aside from the “Type”, “Name”, and “Version” fields, two extra fields exist for an object of this type. These are the “font field” and the “sign field.”

Each font field is an array of 3 values: a font number, a font file name and a cryptographic signature of the content of the font file. The font file name consists of the following: a starting character index represented as a numeric string ending with a line feed, an ending character index represented as a numeric string ending with a line feed, the number of width pixels per character represented as a numeric string ending with a line feed, the number of height pixels per character represented as a numeric string ending with a line feed, and an array of bitmap representation of each character. The character width is zero padded to a multiple of 8 pixels. The sign field contains a unique cryptographic (e.g. SHA-1) signature of all of the values of the font fields in the order presented. The device must examine this signature before accepting and processing the font table object.

### Display Application Object

This is the main object used for an application and normally forms the majority of the objects making up an application. Aside from the “Type”, “Name”, and “Version” fields, two extra fields exist for an object of this type. These are “animation field” and “path field.”

There may be an array of animation fields. Each animation field is an array containing “animation type”, “object name”, “numeric reference”, “row number”, “column number”, “initial loop value”, “end loop value”, “time in millisecond per counter click,” and a status “flag.” The “animation type” can be “GRAPH” to reference a GRAPHIC IMAGE object, “TEXT” to reference a TEXT TABLE object, “LARGE” to select the large font for the device, “PIN” to select the PIN entry screen, “STRING” to select a “string” input line, “AMOUNT” to select an “amount” input line, “LSTRING” to select a large “string” input line, “LAMOUNT” to select a large “amount” input line, or “F_fontname” to select a font from a file called “fontname.fnt”. If nothing is entered for “animation type”, then TEXT is assumed by default.

The “object Name” indicates the name of the object to be animated. This value is needed only if the value of “Animation Type” is GRAPH, TEXT, LARGE, F_fontname or empty. The default value for “Object Name” can be “TEXT TABLE” or “GRAPHICS IMAGE”. Preferably, any other value that appears for “Object Name” is ignored. In some embodiments, the value of this field may be generated by an internal function. For example, the value may be the current date and is generated by a function that returns the current date.

The value of the “numeric reference” field is the prompt number or the image number in the selected “TEXT TABLE” or “GRAPHICS IMAGE” respectively, because objects such as “TEXT TABLE” or “GRAPHICS IMAGE” may contain more than one displayable text or image.

The value of the “row number” field is presented in pixels if a graphics image is referenced, but in lines if a text prompt is referenced. If the number is 256, then the text or graphics image is to be centred.

The value of the “column number” field is in pixels if a graphics image is referenced. If the number is 256, then the text or graphics image is to be centred.

A display Counter is initially set to the “display loop initial value.” The default value for “display loop initial value” is 0. When the display counter reaches the “display loop end value”, the relevant text or image is displayed. The default value for “display loop end value” is 1. If the number of “time in milliseconds per counter tick” starts with zero, then the time is displayed permanently while the current screen is being displayed, and there is no need to redisplay during screen updates. A flag indicates whether the text/graphics should be erased when the counter reaches its initial value again.

There may be an array of “path fields” that define how a current display object exits to another display object. Each path field is an array of the following values: “event type”, “action to perform”, “temporary data element”, and “display object to switch to.”

“Event type” indicates the event whose occurrence triggers a current display object to exit and another display object to be run. The “event” can be a specific keypad value. For example it can be a specific key (such as KEY_{—}1 or KEY_OK. I), or a key group such as KEY_NUM (for example a group of numeric keys). The “event” can alternatively be non-key specific, such as a serial data input, a modem connection, a modem disconnection, a modem data input, a modem data output, a magnetic card swipe reader event, a smart card insertion event, or a certain time value (for example time recorded in milliseconds.)

The value of “action to perform if the event occurs” is represented as an internal nested object of action fields. Each internal field has a tag and a value. The tag can be any of the following: a simple text where it must reference one of the fields in the current display object, an absolute representation of any field within any existing object, or an “empty” value. If a tag for “action to perform if the event occurs” is left empty, then its value is evaluated then discarded. If a value corresponding to the empty tag is also empty, then the action is simply skipped.

The “temporary data element” is created or overridden by a value assigned or appended to the “Action to perform if event occurs” tag. If the value is appended, then an array of data is created and the array of data overwrites the tag temporary data element. Depending on the object that the tag belongs to, the object can further assign a data group and a secure access level to non-group members. The tag of the “temporary data element” can be any of the following: simple text, the key last pressed, a string/numeric input until an OK/ENTER key is pressed, the data read from track 1 of a magnetic card read, the data read from track 2 of a magnetic card read. The value can also be the resulting string of an internal function such as the function used to contact the server (i.e. host), a function used to print to the current printer. It takes one argument which is a current or absolute tag, or a function that prints the value stored within this tag. The internal function can further be one is used to create a pin-block, for example one that takes the following arguments: “track2 tag” used for swiped transactions, “PAN tag” is used for manually entered transactions, and an “amount tag.”

The internal functions can be “( )SUM” means that an aggregate data element must be created containing the sum of the data instead, “( )COUNT” means that a count of the data element must be created or incremented if it already exists, “( )AVG” means the average of the data element must be created instead. This will require the ( )SUM and ( )COUNT to exist as well implicitly. Further examples include “( )MAX” means that the maximum of the data element must be created instead, “( )MIN” means that the minimum of the data element must be created instead.

Other functions can be downloaded as add-ons to the bootloader software as long as they are downloaded securely. These functions are downloaded encapsulated within an object framework with the type “function”. Functions can be replaced by using the same name.

The print function, in particular, may have the following syntax: “\n” indicates an end of a line; “\C” centres the line. “\R” right-justifies the remainder of the line. “\F” selects a large standard font. “\f” selects the normal standard font. “\F_font” selects a font from a font file. Any text within 2 “?” is assumed to be a relative or absolute tag. The value is substituted when printing. The value is obtained from the temporary data element first and if it is still not found then from the object referenced. If the text starts with an aggregate function name, then the aggregate value of the data element is used instead. If the tag starts with “../” then a tag within the last referenced object is used. If a tag start with “.” then the last tag is used. An subscript can also be appended to the tag to select a sub-string of the value from or to another sub-string within the string value.

The “display object to switch to” field is represented as an array of switching fields. Each switching field is an array of 3 values. The first 2 values are compared to each other and if they match, the new object is switched to. Each switching field consists a relative or absolute tag, or an internal function to be called. If this is left blank, then the comparison is considered to be true regardless of the second value. The second value contains a value to which the first value or function output is compared to. In some examples, only the characters are compared, and the comparison result can only be “true” (or “1”, “equal”, “success”, or other equivalent flags) if the tag exists. The third value identifies the object to switch to if the comparison succeeds. If the comparison does not succeed, then the next switching field is evaluated.

In particular, a field with the tag “Type”, a field with the tag “Name”, and a field with the tag “Version” must be created. Other optional fields for the data display object include a “NEW_OBJECT” field. Any new object is created just before displaying the new display object. The “New_Object” consists of an array of field. Each field in the field array contains two components: a tag name for the field, and the value of the field. Another optional field is “CLEAN” field. The value of this field is a text array. The text array indicates an array of tags to remove from the temporary data element list. The value of a “VERIFY” field is a function such as a checksum formula (e.g. Luhn formula) to verify an identification number (e.g. a Luhn digit). It could also be a function to verify to verify the card data just swiped (e.g. ( )MCR), or ( )EMV to verify a chip card (e.g. credit card, Europay card, etc). The value of a “DATA_GROUP” field is the data group number of a temporary data element that belongs to this display object. It also defines the access level of this display object to other temporary data elements. The value of a “NON_GROUP_ACCESS” field defines the access level permitted by non-group objects of any temporary data elements created for this object. This can be NONE, R, W, or RW.

While the present invention has been disclosed with reference to particular examples and details of construction, these should be understood as having been provided by way of example and not as limitations to the scope or spirit of the invention.

What is claimed is:

1. An on-demand download device, comprising:
an object-location software module having access to a memory;
the access being made based on an external input;
a display adapted to present a content specified by the object-location software module;
an object-request software module that is adapted to receive a missing application object name from the object-location software module;
the object-request software module being adapted to generate a request data object based on the name;
the device being adapted to transmit the request data object over a communications network to a host;
the device being adapted to receive an application object from the host and save the application object into the memory;
the application object corresponding to the request data object.

2. The device of claim 1, wherein,
the memory is a persistent memory.

3. The device of claim 2, further comprising,
a display software module for controlling the display, the display software module and the object-location software module belong to an animation software module.

4. The device of claim 1, wherein,
the device transmits a mandatory data object to the host before transmitting the request data object the host, the mandatory data object uniquely identifying the device to the host.

5. The device of claim 1, wherein,
the external input is obtained by a barcode scanner.

6. The device of claim 1, wherein,
the external input is received by an object-name software module, the object-name software module sending an object name to the object-location software module, wherein the request data object comprises the object name.

7. A host for providing an on-demand network, comprising:
an importing tool that imports an object to a database located within a host;
a management module that receives a request data object from a device over a communications network;
the management module retrieving an application object from the database, the application object corresponding to the request data object;
a memory location in which is located a download log, wherein
the management module deploys the application object to the device based on relevant download record in the download log.

8. The host of claim 7, wherein,
the object comprises a field that indicates an enabled or a disabled status.

9. The host of claim 7, wherein,
the host receives a mandatory object from the device, the mandatory object being compared to a configuration object to verify an identity of the device.

10. The host of claim 7, wherein,
the management module comprises a server instruction object, the server instruction object comprising a field that further comprises a name of a correlated application object, wherein the host deploys the correlated application object after deploying the application object.

11. The host of claim 7, wherein,
the host comprises a configuration utility via which a programmer may modify the object.

12. An on-demand download network, comprising,
a device adapted to engage in bi-directional communication with a host;
the device comprising an object-location software module that retrieves an application object based on an external input to the device;
the device further comprising an object-request software module that is adapted to receive a missing application object name from the object-location software module;
the object-request software module being adapted to generate a request data object based on the missing application object name;
the host having a management module for receiving the request data object and identify an application object, based on the request data object, within a host object database;
the host being adapted to transmit an up-to-date copy of the application object to the device.

13. The network of claim 12, wherein,
an existing application object within the device is adapted to generate a general data object based on the external input.

14. The network of claim 13, wherein,
the host is adapted to transmit a data contained in the general data object to a third party server, the data being transformed from the general data object by a custom handler.

15. The network of claim 14, wherein,
the general data object identifies the existing application object and a version of the existing application object, wherein the host accepts or rejects the general data object based on the version.

16. The network of claim 12, wherein,
the external input selects a function to be performed by the device, wherein the missing application object name identifies a missing application object required by the device.

17. The network of claim 16, wherein,
the device comprises an object-request module that generates the request data object to download the missing application object.

18. The network of claim 16, wherein,
a memory location of the host contains a reference table, the reference table containing a download record of the device.

19. The network of claim 12, wherein,
the host comprises a configuration module by which a configuration data for the device can be added or changed, the configuration data belonging to a configuration object.

20. The network of claim 12, wherein,
the host comprises an application programming interface by which the application object can be created or changed.
